(19) United States
(12) Patent Application Publication
(10) Pub. No.: US 2003/0143307 A1
(43) Pub. Date: Jul. 31, 2003

(54) Method for preserving cakes or tarts containing whipped cream

(76) Inventor: Gerhard Bauer, Strasse (DE)

Correspondence Address: Burton S Ehrlich, Arnstein & Lehr, Suite 1200, 120 South Riverside Plaza, Chicago, IL, 60606-3910, US

(21) Appl. No.: 10/332,525

(22) PCT Filed: Jul. 6, 2001
(86) PCT No.: PCT/EP01/07770

(30) Foreign Application Priority Data
Jul. 7, 2000 (DE) 100326188

(51) Int. Cl. C12C 3/04

(52) U.S. Cl. 426/392

(57) ABSTRACT

The invention describes a method for preserving cakes or tarts containing whipped cream, which is characterised in that the confectionery product is placed in a container and is frozen, that the air is exchanged against a protective gas by a gas exchange process, and that thereafter the container is closed air-tight.

The present invention relates to a method for preserving confectionery products containing whipped cream, especially cream-tarts.

It has been known to preserve cakes and tarts, which contain whipped cream, by deep-freezing. Disadvantages of that method are seen in the high costs involved by an uninterrupted deep-freezing chain, and the time required for thawing.

It has further been known to preserve food by packing it in an air-tight container under a protective gas. Setting cakes and tarts, which contain whipped cream, under a protective gas presents the problem that the gas exchange between air and the protective gas causes the whipped cream to collapse.

Further, it has been known to foam up cream with the aid of a protective gas. This is practicable for cream toppings placed on a dessert, but does not give the desired results with layered cakes.

Now, it is the object of the present invention to preserve cakes and tarts, which contain whipped cream, especially in layers, without the expense and costs of a continuous deep-freezing chain.

This object is achieved by a method having the features defined in claim 1.Advantageous further improvements of the invention are the subject-matter of the sub-claims.

The method provides that cakes and tarts, which contain whipped cream, are placed in a container and are frozen, that the air is exchanged against a protective gas by a gas exchange process, and that thereafter the container is closed air-tight, the order of the steps of placing the cake or tart in the container and freezing it being exchangeable. Preferably, however, the cake or the tart is placed in the container first and frozen thereafter because that sequence simplifies the process and can be carried out at lower cost, compared with the other order of succession.

The freezing process permits the air to be exchanged against a protective gas without the whipped cream collapsing, because the foamy structure of the cream has been stabilised by the freezing process. Insofar, the freezing step proposed by the invention does not serve the purpose to preserve the product by lowering the temperature; rather, the freezing step is used as a means for exchanging the air against a protective gas in the whipped cream without causing the whipped cream to collapse. The invention therefore does not require that the cakes and tarts be cooled down to the temperature of −18° Celsius to −22° Celsius usual for deep-frozen food. Instead, following the gas exchange and closing of the container, the product may, and preferably is, thawed out because the cakes and tarts then look most appetising.

Preferably, the temperature of the tart is lowered according to this method only to the degree absolutely necessary to mechanically stabilise the whipped cream by the freezing process so far that it will not collapse during the gas exchange. It is, thus, possible to carry out the freezing step at a temperature of approximately −10° to −16° Celsius. Preferably, freezing is effected at a temperature of −12° to −15° Celsius. Having cooled down to that temperature, the containers, with the frozen cake or the frozen tart contained therein, can then be transferred from the freezing chamber into a gas exchange chamber. It is of course also the possible to carry out the gas exchange directly in the freezing chamber although the possibility mentioned before is more efficient and cheaper.

To cool the product to temperatures lower than those mentioned above would cause unnecessary energy costs so long as it is only intended to perform the gas exchange in the whipped cream.

Upon completion of the gas exchange the cakes or tarts can be either cooled down to-the storage temperature of −18°0 to −22° Celsius usual for deep-frozen food, for longer storage, or thawed out to room temperature or to refrigerator temperature (approximately 2° to 8° Celsius), at which temperature cream tarts will typically keep for approximately two weeks. If they had been deep-frozen, the tarts will likewise keep for approximately another two weeks under the protective gas present.

After removal from the container, the cakes and tarts then appear like fresh-made products, and this especially if they had not been deep-frozen.

Preferably, the gas exchange is effected by sucking off the air and flooding the container with the protective gas, as this permits the process to be carried out rapidly. The protective gas should, if possible, contain no oxygen, be inert and, especially, be non-acidic in order to avoid spoilage by micro-organisms and turning sour of the cream.

Preferably, the protective gas used is nitrogen, that gas is well-suited for that purpose and is available at low cost.

The use of this method now permits to store layered cream-tarts, especially Black Forest Gateau and similar layered cream-tarts, in shops, cafés and restaurants unchilled, moderately chilled in refrigerated shelves or in deep-frozen condition in deep freezers or deep-freezing cabinets, A special advantage is seen in the fact that now even medium-sized baker's and confectioner's shops are in a position to produce well-keeping cakes and tarts containing whipped cream for their own use or for sale to cafés and restaurants, without having to provide for a continuous refrigeration or deep-freezing chain. The invention is of particular advantage to restaurants and cafés that need to have available unchilled or thawed tarts and cakes, for example awaiting a weekend when lots of holiday traffic are expected, and that heretofore were left with, and had to destroy, such tarts and cakes when the expected visitors failed to come, for example as a result of a sudden change in the weather. Cakes and tarts, that have been preserved in accordance with the method of the invention and that have not been opened, can be stored in such a case without any particular refrigeration requirements for another two weeks or so. In the caféor restaurant, the cakes and tarts can be taken from the sealed container immediately before they are consumed, and are then available fresh and appetising. Tarts not consumed can be stored without any difficulty and can be offered for consumption after a couple of days in appetising condition. This is an enormous cost advantage for operators of cafés and restaurants

The method can be applied with advantage also to the preservation of food that contains whipped cream, for example to the preservation of desserts.

1. Method for preserving a cake or a tart, that has been produced using whipped cream, characterised in that the cake or the tart is placed in a container and is frozen, that the air is exchanged against a protective gas by a gas exchange process, and that thereafter the container is closed air-tight, the order of the steps of placing the cake in the container and freezing it being exchangeable.

2. The method as defined in claim 1, characterised in that the temperature of the cake or the tart, respectively, is lowered during the freezing process only to an extent required to prevent the whipped cream from collapsing when sucking off the air.

3. The method as defined in claim 1 or claim 2, characterised in that the cake or the tart, respectively, is frozen to a temperature of −10° to −16° Celsius.

4. The method as defined in claim 1 or claim 2, characterised in that the cake or the tart, respectively; is frozen to a temperature of −12° to −15° Celsius.

5. The method as defined in any of the preceding claims, characterised in that the gas exchange is effected by sucking off the air followed by flooding with a protective gas.

6. The method as defined in any of the preceding claims, characterised in that the protective gas used is nitrogen.

7. The method as defined in any of the preceding claims, characterised in that after freezing in a freezing chamber, the cakes or tarts, respectively, contained in their containers, are transferred from the freezing chamber into a separate, not necessarily but preferably chilled gas exchange chamber; where the gas exchange and thereafter the closing of the containers is carried out.

8. The method as defined in any of claims 1 to 6, characterised in that the entire process is carried out in one and the same chamber.

9. The method as defined in any of the preceding claims, characterised in that the cake or the tart, respectively, is allowed to become thawed after closing of the container.

10. The method as defined in claims 1 to 8, characterised in that after closing of the container the temperature is lowered to a value usual for storing deep-frozen food, especially to a value of −18° to −22° Celsius.

11. Using the method as defined in any of the preceding claims for preserving layered cream-tarts, especially Black Forest Gateau.

12. Using the method as defined in any of claims 1 to 10 for preserving food other than cakes and tarts that is produced using whipped cream.
